(19) United States
(12) Patent Application Publication
(10) Pub. No.: US 2017/0147967 A1
(43) Pub. Date: May 25, 2017

(54) REAL-TIME PALLET ALLOCATION

(71) Applicant: Tata Consultancy Services Limited, Mumbai (IN)

(72) Inventors: Umesh Chandra BEHERA, Mumbai (IN); Ajay Bansal, Dallas, TX (US)

(73) Assignee: Tata Consultancy Services Limited, Mumbai (IN)

(21) Appl. No.: 15/019,682

(22) Filed: Feb. 9, 2016

(30) Foreign Application Priority Data
Nov. 20, 2015 (IN) 4374/MUM/2015

(51) Int. Cl. G06Q 10/08

(52) U.S. Cl. CPC G06Q 10/087

(57) ABSTRACT

This disclosure relates generally to inventory management, and more particularly to allocating pallet locations to items in a distribution center. In one embodiment, the method includes receiving an input including an item identifier. Based on the item identifier, a load distribution information is accessed. Based on the load distribution information associated with the item and one or more allocation parameters associated with the one or more pallet locations, one or more pallet locations from amongst a plurality of pallet locations are determined. The one or more allocation parameters are indicative of the availability of pallets at the one or more pallet locations in real-time. At least one pallet location is selected from amongst the one or more pallet locations based on a location identifier associated with the at least one location, for accommodating the item. The location identifier is indicative of prioritization of the pallet location for accommodating the item.

### PRIORITY CLAIM

This U.S. patent application claims priority under 35 U.S.C. §119 to: India Application No. 4374/MUM/2015, filed on Nov. 20 2015. The entire contents of the aforementioned application are incorporated herein by reference.

### TECHNICAL FIELD

This disclosure relates generally to inventory management, and more particularly to allocation of pallet locations to inventory items in a staging area of a distribution center.

### BACKGROUND

Inventory refers to items or merchandise that is stocked for use in future. Retail chains have their own distribution centers for stocking large quantities of items or merchandise of varied products/materials which can later be shipped to stores and/or demand centers as per demand. The stock of goods in the distribution center is tracked mostly by skilled personnel, to make sure that there is surplus inventory in the distribution center.

Typically, the distribution centers include three primary sections, namely, a receiving area for receiving the products/materials, a staging area for storage of the products/materials, and an area for facilitating on-demand outbound shipments of the products/materials. The productivity at the receiving area is an important factor in governing the flow of material through the distribution center and meeting requirements in the staging area. In addition, the productivity at the receiving area is important in enabling quick product availability to fulfill downstream replenishment need, and a demurrage paid to the carriers for delayed unloading and yard space requirement

In conventional unloading method a manual process is employed, where separate pallet locations are pre-allocated for different items. Trucks are generally filled randomly with items by the vendors. The inventors here have recognized several technical problems with conventional methods, as explained below. The manual process of unloading creates mismatch in the item sequence in the truck and the sequence of the locations which are pre-allocated by the receiving crew, thereby encouraging random walking by unloading associates which leads to higher time for unloading and effort loss due to excess walking. The problem grows with the number of items in the truck. In case item mix is high, sorting of items becomes more tedious with high walking around the conveyor belt meant to export the items in the staging area. Also, the sorters have to be engaged in frequently referring a paper based reference sheet to find a correct location for an item by matching the item number/SKU (stock keeping unit) number associated with the item.

### SUMMARY

Embodiments of the present disclosure present technological improvements as solutions to one or more of the above-mentioned technical problems recognized by the inventors in conventional systems. For example, in one embodiment, a processor-implemented method for real-time allocation of pallet locations to items in a staging area in a distribution center is provided. The method includes receiving, via one or more hardware processors, an item identifier corresponding to an item from amongst a plurality of items. Further, the method includes accessing, via the one or more hardware processors, and based on the item identifier, a load distribution information comprising at least a quantity of the item, an item category of the item, a number of pallets, and a pallet capacity of the pallets for accommodating the item. Furthermore, the method includes determining, via the one or more hardware processors, availability of one or more pallet locations of a plurality of pallet locations based on the load distribution information associated with the item and one or more allocation parameters associated with the one or more pallet locations. The one or more allocation parameters are indicative of the availability of the pallets at the one or more pallet locations in real-time for accommodating the item. Moreover, the method includes selecting, via the one or more hardware processors, at least one pallet location from amongst the one or more pallet locations for accommodating the item. The at least one pallet location is selected based on a location identifier associated with the at least one pallet location, wherein the location identifier associated with a pallet location is indicative of prioritization of the pallet location for accommodating the item.

In another embodiment, a processor-implemented system for real-time allocation of pallet locations to items in a staging area in a distribution center is provided. The system includes one or more memories, and one or more hardware processors. The one or more memories are coupled to the one or more hardware processors wherein the one or more hardware processors are capable of executing programmed instructions stored in the one or more memories to receive an item identifier corresponding to an item from amongst a plurality of items. Further, the one or more hardware processors are capable of executing programmed instructions to access, based on the item identifier, a load distribution information comprising at least a quantity of the item, an item category of the item, a number of pallets, and a pallet capacity of the pallets for accommodating the item. Furthermore, the one or more hardware processors are capable of executing programmed instructions to determine, for accommodating the item, availability of one or more pallet locations of a plurality of pallet locations based on the load distribution information associated with the item and one or more allocation parameters associated with the one or more pallet locations. The one or more allocation parameters are indicative of the availability of the pallets at the one or more pallet locations in real-time. Moreover, the one or more hardware processors are capable of executing programmed instructions to select at least one pallet location from amongst the one or more pallet locations for accommodating the item, the at least one pallet location being selected based on a location identifier associated with the at least one pallet location. The location identifier is associated with a pallet location is indicative of prioritization of the pallet location for accommodating the item.

In yet another embodiment, a non-transitory computer-readable medium having embodied thereon a computer program for executing a method for real-time allocation of pallet locations to items in a staging area in a distribution center is disclosed. The method includes receiving an item identifier corresponding to an item from amongst a plurality of items. Further the method includes, accessing, based on the item identifier, a load distribution information comprising at least a quantity of the item, an item category of the item, a number of pallets, and a pallet capacity of the pallets for accommodating the item. Furthermore, the method includes determining, for accommodating the item, availability of one or more pallet locations of a plurality of pallet locations based on the load distribution information associated with the item and one or more allocation parameters associated with the one or more pallet locations. The one or more allocation parameters are indicative of the availability of the pallets at the one or more pallet locations in real-time. Moreover, the method includes selecting at least one pallet location from amongst the one or more pallet locations for accommodating the item, the at least one pallet location being selected based on a location identifier associated with the at least one pallet location, wherein the location identifier associated with a pallet location is indicative of prioritization of the pallet location for accommodating the item.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIGS. 1A, 1B and 1C show exemplary illustration of a receiving area of a distribution center according to some embodiments of the present disclosure.

FIG. 2 is a functional block diagram of a system for inventory management according to some embodiments of the present disclosure.

FIG. 3 illustrates a distribution of pallet locations in a receiving area of a distribution center in accordance with some embodiments of the present disclosure.

FIG. 4 is a user interface of a system for inventory management according to some embodiments of the present disclosure.

FIG. 5 is a flow diagram illustrating method for allocating pallet locations to inventory items in accordance with some embodiments of the present disclosure.

FIG. 6 is a flow diagram illustrating method for determining load distribution information in accordance with some embodiments of the present disclosure.

FIGS. 7A and 7B is a flow diagram illustrating method for allocating pallet locations to inventory items in accordance with some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

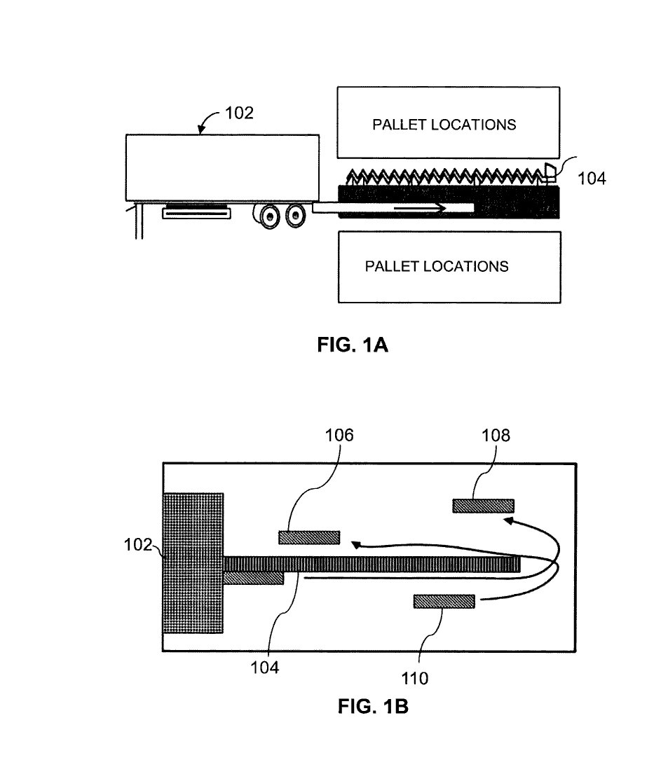

The present disclosure relates to a system and methods for inventory management. Various embodiments herein disclose systems and methods for unloading of inventory items in a distribution center. A distribution center is a specialized facility designed to store large quantities of varied products/material for shipment to stores/demand centers, as per the demand. The distribution center includes three main sections, namely a receiving area for receiving or unloading of the products/material, a storage area for storing the products/material, and an area for facilitating on-demand outbound shipments of said products/material. The productivity, or in other words efficiency of unloading the products/materials at the receiving area is an important factor governing various operations in the distribution center. An example of the receiving area of the distribution center is described further in detail with reference to FIGS. 1A-1C.

FIGS. 1A, 1B and 1C illustrates a receiving area 100 of a distribution center in accordance with an example embodiment. The inventory items can be transported in a vehicle 102 (such as truck) to and from the distribution center. For efficient and convenient unloading of the items from the vehicle, the vehicle can be parked inside or in close proximity to the receiving area 100. The receiving area 100 includes a conveyer 104 for receiving the items. Herein, the conveyer 104 may be a rollers-based motor operated flexible conveyor that can be used to carry cartons having the items from within the truck 102 to the staging area of the distribution center. The cartons having the items are removed from within the truck 102 and placed on the conveyer 104. An associate (also known as unloader) may be responsible for removing cartons from within the truck 102 and placing them on the conveyer 104. The items on the conveyer 104 are sorted, for instance, by a sorter associate, who is responsible for sorting the cartons arriving on the conveyer 104, and places individual items on separate pallets. Herein, the term “pallet” refers to wooden blocks on which cartons can be stacked to create a single operable unit for storage in the storage bins in the distribution center. On placing the cartons onto the pallets, the pallets are then moved to the storage area where the cartons are stored in the storage bins.

The conventional method of unloading products/items includes a manual process where separate pallet locations are pre-allocated for different items. Herein, the term “pallet location” refers to a location identifier of a place in the receiving area 100 where the pallet is placed. In an embodiment, the location identifier may include a location number. Trucks are generally filled randomly with items by the vendors, creating a mismatch in the item sequence in the truck and the sequence of the locations which are pre-allocated by the experts/associates at the receiving area. As such, the unloading associates have to indulge in random walking for unloading the items and placing the items on the pallets. For instance, as illustrated in FIG. 1B, the items from the conveyor 104 are taken to various pallet locations such as 106, 108, 110 and so on, in a random manner. Due to random motion of the unloading associates in the receiving area, substantial effort is loss because of excessive walking, thereby leads to greater time for unloading. In addition, when the number of items in the truck is high, such random movement and excessive walking leads to further unproductive unloading in the receiving area. There may be instances when the product mix of the items in the truck is high, and thus the sorting of products may become tedious with high walking around the conveyor 104. Also, the sorter associates (who are responsible for unloading the items from the conveyer 104 and placing said items on the pallets) are needed to frequently refer a paper based reference sheet to find the correct location for an item by matching the item identifier. Herein, the item identifier may include a stock keeping unit (SKU) number. The SKU number associated with an item refers to a unique identification for said item.

Various embodiments of the present disclosure provide methods and systems for efficient management of unloading of items from the vehicle (such as, the truck) and replenishing pallets in a staging area of the distribution center. The staging area in the distribution center is a location for receiving, loading, and distributing the items in the distribution center. The staging area in particular, is a place in the distribution center where the inventory is initially processed for sorting out before finally moving out the item to a storing location. For instance, systems disclosed herein enables in interaction with the unloading associates through voice to facilitate the sorting associates locate the correct location of an item immediately. Additionally, the disclosed systems dynamically allocate the nearest possible location to an item to reduce walking around the conveyer 104. For instance, as illustrated in FIG. 1C, the dynamic allocation of the items allows in systematic allocation of items to the pallets (such as pallets 112, 114, 116 and 118) based on weight and volume of the items. Further, the methods and systems allocate heavier products/materials to locations near the conveyer 104 and lighter products to locations relatively far from the conveyer 104. The dynamic allocation of items to the pallets also allows in performing all other tasks such as mixing of products in a single pallet in case the quantity ordered is very less for certain items, allocating special locations for items with higher quantity and so on, which are followed in the normal process.

The dynamic allocation of pallet locations facilitates in reducing the walking around the conveyer 104 during pallet building by allocating the nearest possible location to an item. As the allocation happens dynamically, all the items at rear end of the trailer (which comes out first) are allocated to pallet locations closer to the truck door, and the items at nose of the trailer are allocated to pallet locations that are farther from the truck door, thereby facilitating a gradual fill of floor space and by doing this the random motion of sorting associates is controlled. The disclosed methods and systems also prevent the sorter associates to change sides along the conveyer 104 frequently, which reduces walking effort.

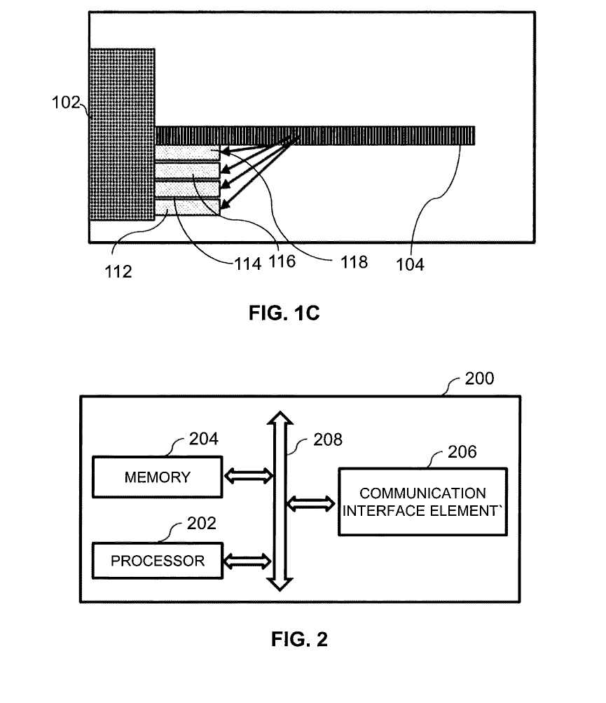

A system for dynamic allocation of pallets (or pallet locations) to the Items associated with the inventory is disclosed further with reference to FIG. 2. The manner, in which the system and method for allocation of pallets to items for inventory management in the distribution centre shall be implemented, has been explained in details with respect to the FIGS. 2 through 6. While aspects of described methods and systems for inventory management can be implemented in any number of different systems, utility environments, and/or configurations, the embodiments are described in the context of the following exemplary system(s).

FIG. 2 illustrates a block diagram of a system 200 for inventory management, in accordance with an embodiment of the present disclosure. In an embodiment, the system 200 facilitates in dynamic allocation of pallet locations for unloading of items of the inventory. The system 200 includes or is otherwise in communication with at least one processor such as a processor 202, at least one memory such as a memory 204, and a user interface 206. In an embodiment, the processor 202, memory 204, and the memory 204, and the user interface 206 may be coupled by a system bus such as a system bus 208 or a similar mechanism.

The processor 202 may include circuitry implementing, among others, audio and logic functions associated with the communication. For example, the processor 202 may include, but are not limited to, one or more digital signal processors (DSPs), one or more microprocessor, one or more special-purpose computer chips, one or more field-programmable gate arrays (FPGAs), one or more application-specific integrated circuits (ASICs), one or more computer(s), various analog to digital converters, digital to analog converters, and/or other support circuits. The processor 202 thus may also include the functionality to encode messages and/or data or information. The processor 202 may include, among other things, a clock, an arithmetic logic unit (ALU) and logic gates configured to support operation of the processor 202. Further, the processor 202 may include functionality to execute one or more software programs, which may be stored in the memory 204 or otherwise accessible to the processor 202.

The at least one memory such as a memory 204, may store any number of pieces of information, and data, used by the system to implement the functions of the system. The memory 204 may include for example, volatile memory and/or non-volatile memory. Examples of volatile memory may include, but are not limited to volatile random access memory (RAM). The non-volatile memory may additionally or alternatively comprise an electrically erasable programmable read only memory (EEPROM), flash memory, hard drive, or the like. Some examples of the volatile memory includes, but are not limited to, random access memory, dynamic random access memory, static random access memory, and the like. Some example of the non-volatile memory includes, but are not limited to, hard disks, magnetic tapes, optical disks, programmable read only memory, erasable programmable read only memory, electrically erasable programmable read only memory, flash memory, and the like. The memory 204 may be configured to store information, data, applications, instructions or the like for enabling the UAV to carry out various functions in accordance with various example embodiments. Additionally or alternatively, the memory 204 may be configured to store instructions which when executed by the processor 202 causes the system 200 to behave in a manner as described in various embodiments.

In an embodiment, the system 200 is caused to determine load distribution information associated with a plurality of items to be delivered in the truck. The determination of the load distribution information may facilitate in assigning categories to various items to be delivered. Said item categories can be utilized in dynamically allocating pallet locations to different items during unloading of the items from the truck and/or sorting of the items. Also, the determination of the load distribution information may facilitate in prior planning of unloading the items at the pallet locations, and therefore in determining best pallet locations for unloading the items. In an embodiment, the load distribution information can be determined prior to arrival of the truck at the distribution center.

The load distribution information is determined based on inventory information regarding quantity and characteristics of the items to be delivered at the distribution center, and a total available floor capacity in the receiving area. In an embodiment, the processor 202 is configured to, with the content of the memory 204, and optionally with other components described herein, cause the system 200 to receive the inventory information associated with the items to be delivered in the truck. The inventory information may include information regarding vehicle details (such as number or identification of the vehicle), number of SKUs in the vehicle, expected quantity of the items pertaining to each SKU, supplier identification (ID) responsible for supplying the items, purchase order (PO) data from a distribution center's warehouse, and so on. The term “PO” may refer to the purchase order document sent to the vendor for order fulfillment. The PO contains item number, quantity ordered and vendor information.

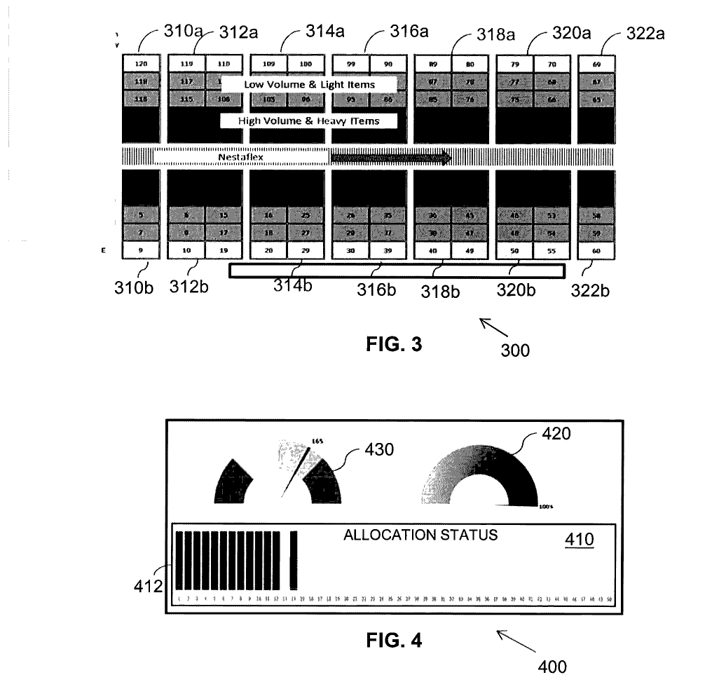

The system 200 is caused to utilize the inventory information for determining total volume of products that are to be delivered in the vehicle, which may further facilitate in assigning item categories to the items. Additionally, the system 200 is caused to estimate a number of pallets (or pallet locations) needed for unloading the items based on the inventory information. The pallets may be arranged in a plurality of rows on the floor of the receiving area, as is described with reference to FIG. 3C. Further, a pallet depth of each row along the conveyor (for example, the conveyor 104) is determined. In an embodiment, the pallet depth represents the number of pallets that can be accommodated in a row on the floor of the distribution center. In an embodiment, the pallet depth of each row can be calculated as:

Pallet depth of a row=Maximum number of rows available in floor
Total number of Pallet load expected in the truck

Herein, a pallet load may be determined as dimension (Area×Height) of a pallet with number of cartons as unit of dimension. For example, a pallet load of 6×3 can be referred to as 6 cartons in area with 3 carton height in the pallet.

The system 200 is further caused to determine/assign item categories associated with the plurality of items based on an item priority ranking being assigned to each item. In an embodiment, the item priority ranking can be determined based on volume and weight of the item. For example, the priority ranking of an item is determined as under:

Item priority ranking of an item=Volume of the item*Weight of the item

In an embodiment, the system 200 is caused to assign item priority ranking into a number of categories (or item categories) equal to a predetermined pallet depth. For example, if a row depth is 5 (i.e. 5 pallets can be kept in each row), then the items may be classified in 5 categories e.g. “Priority item category A” product, “Priority item category B” product till “Priority item category E” product. In an embodiment, the system 200 is caused to assign the item priority ranking to the items based on a number of locations of each item category available on the floor and an estimated number of pallets an item type would occupy. For instance, an “A” product with requirement of four pallets can occupy two “A category” pallets locations and two “B category” pallet locations. The system 200 is caused to sort the plurality of items in descending order of priority weightage (or item priority ranking) thereof, and assign best available item category to each item one by one. In an embodiment, the availability of pallet locations is re-calculated once the item category is assigned to an item (before moving on to the next item).

The system 200 is further caused to determine the floor capacity of the receiving area that may be utilized for accommodating the items after unloading from the truck. The floor capacity is determined in alignment with ranking/prioritization of pallet locations in a row. In an embodiment, the system 200 is caused to assign a location identifier indicative of the prioritization of pallet locations to each of the plurality of pallet locations based on a distance of said pallet location relative to the conveyor. For instance, pallet rows at either side of an aisle may be given odd numbers or even numbers, such that the location ranking numbers start from the conveyor side. Such assignment of location identifiers may ensure that the higher ranking locations have smaller numbers than the lower ranking location in a row. A schematic diagram of floor numbering and distribution of pallet locations is described with reference to FIG. 3.

The system 200 is caused to maintain one or more allocation parameters, in real-time, for allocating pallet locations to the items. The one or more allocation parameters may include, in addition to the location category associated with the plurality of pallet locations; a location status information, number of continuous unoccupied pallet locations adjacent to a pallet location, item part family information and vendor identifier, percentage of pallet space filled corresponding to a pallet, and a zone information associated with a plurality of zones in the distribution center.

The ‘location status information’ associated with the pallet location includes a status of the pallet location in real-time, where the location status is one of an available status, a filled status and a partially filled status. In an embodiment, the system 200 is caused to allocate partially filled locations to other items which can fit in the remaining space and should be of same part family and from same vendor or any other criteria suited for the warehouse.

The number of continuous unoccupied pallet locations adjacent to a pallet location includes unoccupied pallet locations adjacent to the pallet location having same location category as that of the incoming item which is being unloaded from the truck and is ready to be sorted. The dynamic allocation based on the determination of the number of continuous pallet locations adjacent to the pallet location that are not occupied ensures that an item with “n” pallets is not assigned a pallet location which has less than “n” continuous non-occupied locations.

The product part family information includes product part family and a vendor ID of the item. The system 200 is caused to maintain the product part family information for the items once location is assigned to said items. The system 200 is caused to maintain, in real-time, information associated with percentage of pallet space filled. For instance, in case an item with less than one pallet is assigned to a pallet location, the system 200 may allocate other items with partial pallet requirement to the pallet location so as to build a mixed pallet.

The zone information may refer to information regarding a plurality of zones into which the available floor space of the receiving area of the distribution center can be divided. For the purpose of inventory management in the reeving area, the floor space of the receiving area is divided into pre-determined zones with equal spacing, where each zone includes a set of pallet locations. Each pallet location is associated a zone ID such that the pallet locations in a particular zone may be assigned same zone ID. In an embodiment, a zone-based allocation of pallet location may be performed (instead of an item categorization based allocation) if total number of pallets occupied on the entire floor at any point of time exceeds the total capacity of a zone and its preceding zones. Here, the preceding zone may refer to that zone which is associated with a higher zone ranking as compared to a current zone. In the zone-based allocation of pallet location, the system is caused to dynamically change the priority rankings (or location categorization) for all the pallet locations which are unoccupied in the zone, and match with the item categorization of the incoming item (the item on the conveyer which needs to be assigned a pallet location). For example, the system 200 may be caused to determine whether the number of occupied pallet locations is greater than or equal to the total capacity of the zone and one or more preceding zones. Herein, it will be noted that the term ‘number of pallet locations’ refers to a total number of pallet locations in the receiving area which are occupied at any point of time. If it is determined that the total number of occupied pallet locations is greater than or equal to the total capacity of the zone and one or more preceding zones, the system 200 is caused to change the location category corresponding to the plurality of unoccupied pallet locations to match with the item category of the item. This ensures rapid filling of a zone in case the gradual fill was lost due to non-uniform product distribution in the vehicle.

The system 200 is caused to dynamically optimize allocation of pallet locations to the items based on the one or more allocation parameters, the load distribution information and a plurality of rules. In an embodiment, the system 200 may be embodied in a computing device, for instance a server, and may facilitate in dynamically optimizing allocation of pallet locations to the items. The plurality of rules may be stored in the memory 204 of the system 200 for facilitating dynamic allocation of pallet locations to the items.

In an embodiment, the system 200 is caused to receive a voice input identifying an item, from an associate. For instance, the voice input may include an item identifier (such as a SKU number of the item) associated with an item that is to be unloaded and placed at a pallet location. On receipt of the voice input, the system 200 is caused to assign, based on the one or more allocation parameters and a plurality of rules, one or more pallet locations where the item can be unloaded. In an embodiment, the voice input may be received from a device held by the sorter associate, where the device may include an input interface for receiving voice input from the sorter associate. In some embodiments, only last three digits of the item identifier can be provided by the sorter associate so as to make the process more efficient. In case there is any conflict with last three digits, the system 200 may prompt for higher digits. In an embodiment, the device can be communicatively coupled to the system 200 for sending the voice input to the system 200.

In an embodiment, the system 200 may include a communication interface element 206 for receiving the voice input provided by the sorter associate, and facilitate communication between the device held by the sorter associate and the system 200. The communication interface element 206 may be in form of a wireless connection or a wired connection. Examples of communication interface element 206 may include, but are not limited to, IEEE 802.11 (Wifi), BLUETOOTH®, or a wide-area wireless connection. Example of wired communication interface 206 includes, but is not limited to Ethernet. The processor 202 may also be configured to facilitate communications via the communication interface element 206 by, for example, controlling hardware included within the communication interface element 206. In this regard, the communication interface element 206 may include, for example, communications driver circuitry (e.g., circuitry that supports wired communications via, for example, fiber optic connections), one or more antennas, a transmitter, a receiver, a transceiver and/or supporting hardware, including, for example, a processor for enabling communications.

The system 200 is caused to access, based on the item identifier, the load distribution information associated with the item. The load distribution information includes at least quantity of the item, an item category of the item, a vendor ID of the item, a number of pallets, and a pallet capacity of the pallets for accommodating the item. In an embodiment, based on the load distribution information, the system 200 is caused to determine whether or not the number of pallets needed for the Item is less than one. In an embodiment, on determination that the number of pallets needed for accommodating the item is less than one, the system 200 is caused to change the status of all the partially filled pallet locations with same part family and vendor ID as that of the item to “Available”, The system 200 is further caused also change location category of said partially filled pallet locations to match the item category of the item. For example, if the item in question is assigned a priority category as “C” category, the location category of all the partially filled locations with the same part family and vendor ID as that of the item may be changed to “C”. This can be done to expedite the filling of locations which are already filled partially but would need more items to become full.

In an embodiment, the system 200 is caused to determine that the number of pallets needed for accommodating the items is equal to or more than one. In this embodiment, the system 200 is caused to change the status of the pallets location having a status thereof as “Partially filled” to a status as “Not Available”. In an embodiment, the system 200 is caused to change the status of all non-filled locations with priority category not matching to the incoming item (or SKU) to “Not-available”. In addition, the system 200 is caused to determine, in real-time, a number of occupied pallet locations based on the status information associated with the plurality of pallets as ‘partially filled’ and ‘not available’.

The system 200 is further caused to determine whether the number of occupied pallet locations is greater than or equal to a total capacity of a zone and one or more preceding zones in the distribution center. If it is determined that the number of occupied pallet locations is greater than or equal to the total capacity of the zone and one or more preceding zones, the system 200 is caused to change the location category corresponding to the plurality of unoccupied pallet locations to match with the item category of the item (for example, the incoming SKU). This ensures rapid filling of a zone in case the gradual fill was lost due to non-uniform product distribution in the truck.

In an embodiment, the system 200 may determine that the number of occupied pallet locations is less than the total capacity of the zone and one or more preceding zones. In the present embodiment, the system 200 is further caused to determine, based on the one or more allocation parameters, availability of at least one pallet location associated with the ‘available’ status information and a predefined location category. The system 200 is further caused to determine non-availability of an item associated with the item category same as the predefined location category. For instance, sometimes an unfilled location may be left alone in the receiving area as no more items of the required category with just one pallet load are left in the truck. In such instances, where there are one or more an unfilled pallet locations left in the area, the system 200 may be caused to dynamically change the location category associated with said pallet locations to match with the item category of the incoming item, thereby ensuring quick filling of pallets at such pallet locations.

The system 200 may further be caused to determine, based on the one or more allocation parameters, a number of continuous unoccupied pallet locations adjacent to a pallet location having the location category same as the location category of the item. On determination of the number of continuous unoccupied pallet locations adjacent to the pallet location being less than the number of pallet locations needed for accommodating the item, the system 200 is caused to change the status of the pallet location as ‘not available’.

As discussed in various embodiments above, the system 200 is caused to determine availability of the one or more pallet locations for accommodating the item based on the load distribution information associated with the item and one or more allocation parameters associated with the one or more pallet locations. The system 200 is further caused to select at least one pallet location from amongst the plurality of locations based on the location identifiers associated with the one or more pallet locations. For instance, the system 200 is caused to compare the location identifiers associated with the one or more pallet locations, and select a pallet location associated with highest priority (or lowest location identifier). The system 200 may further be caused to communicate the selected pallet location to sorter associate. In an embodiment, the pallet location can be communicated to the sorter associate, through the communication interface element 206, at the device held by the sorter associate. In an embodiment, the pallet location can be communicated in form of a voice message (or voice file), a text message, and any other similar means of communication.

FIG. 3 illustrates a distribution 300 of pallet locations in a receiving area of a distribution center, in accordance with an example embodiment. As illustrated, the receiving area is shown to include a conveyor 302 and a plurality of pallet locations arranged in a plurality of rows on both the sides of the conveyor 302. For instance, the receiving area includes pallet locations such as pallet locations 310a, 312a, 314a, 316a, 318a, 320a, and 322a on one side of the conveyer 302, and pallet locations such as pallet locations 310b, 312b, 314b, 316b, 318b, 320b, and 322b on another side of the conveyer 302. The pallet locations on the floor can be numbered (or given location identifiers) in alignment with priority rankings in a row. Pallet rows at either side of an aisle are given odd numbers or even numbers, and the number start from the conveyor side, thereby ensuring that the higher priority locations have smaller numbers than the lower priority location in a row. For instance, out of the priority locations numbered 1, 3, 5, 7, 9 and in the row 310a, the priority location numbered 1 is of highest priority and the priority location numbered 9 is of lowest priority. The pallet locations in a row are given location priority ranking (such as A, B, C, D, and E), where the location priority A can be highest priority (closest to the conveyor) and the location priority can be of lowest priority (farthest from the conveyor).

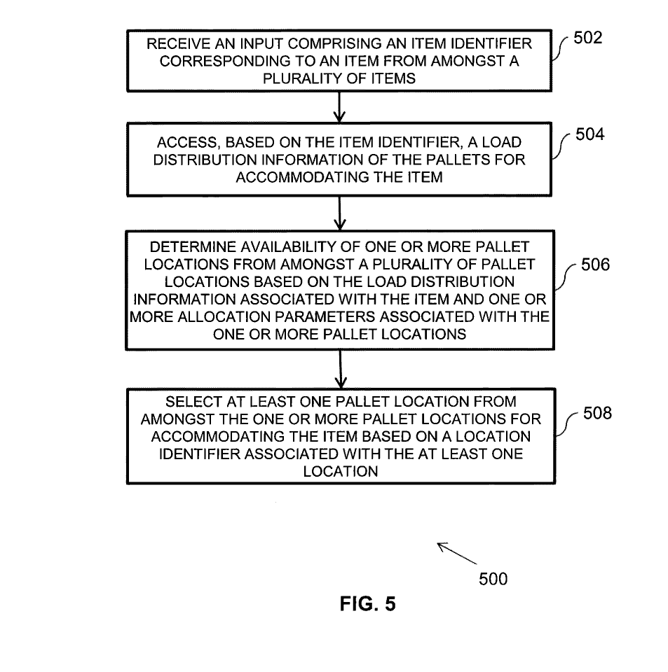

FIG. 4 illustrates a user interface 400 of a system for inventory management, in accordance with an example embodiment. The user interface 400 is shown to include an allocation status 410, truck progress 420, volume controls 430 associated with voice inputs and output, and so on. The allocation status 410 provides a status of filling up of different rows of pallets (or pallet locations) in the receiving area. For instance, some of rows such as a row 412, which are completely filled can be displayed in a green color. The truck progress bar 420 is indicative of materials (or items) remaining in the truck. Also, the volume controls 430 are controls for adjusting volume adjusting volume of the voice input provided by the sorter associate and as well the voice output received from the system, for instance the system 200. It will be noted herein that the UI 400 disclosed herein is an example user interface, and various other variations of UIs corresponding to a system for dynamic allocation of the pallet location may be possible.

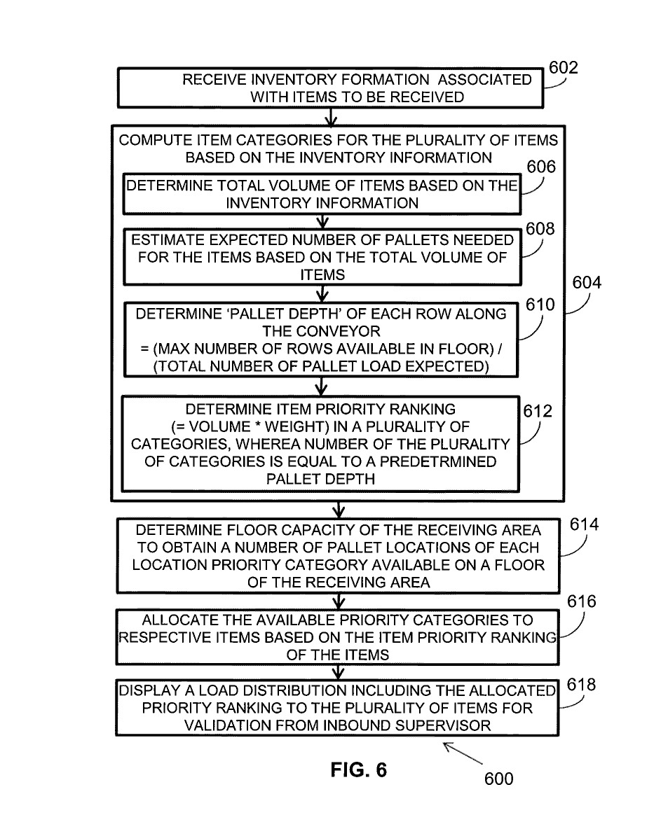

FIG. 5 illustrates a flow diagram of a method 500 for allocating pallet locations to inventory items, in accordance with the present disclosure. The distribution center may include a plurality of pallet locations arranged in a plurality of rows for accommodating the items. An example of arrangement of the plurality of pallet locations in the distribution center is described with reference to FIG. 3. In an embodiment, for allocating pallet locations in real-time to the inventory items, a system for instance the system 200 (FIG. 2) is provided, where the system 200 is configured to initially determine load distribution information associated with the items in a receiving area of the distribution center. The determination of the load distribution information may facilitate in assigning item categories to various items. Said item categories can be utilized in dynamically allocating pallet locations to different items during unloading of the items from the truck. A method 500 for dynamically allocating the pallet locations to the plurality of items is described.

At 502, an input including an item identifier corresponding to an item from amongst a plurality of items is received. In an embodiment, the input is received at the system 200. For instance, the input may include an item identifier (such as a SKU number of the item) associated with an item that is to be unloaded and placed at a pallet location. In an embodiment, the input may include a voice input. The voice input may be a voice utterance identifying the item provided by a sorter associate. In an embodiment, the voice input may be received from a device held by the sorter associate, where the device may include an input interface for receiving voice input from the sorter associate. In some embodiments, only last three digits of the item identifier can be provided by the sorter associate so as to make the process more efficient. In case there is any conflict with last three digits, the system 200 may prompt for higher digits

On receipt of the input, the system 200 is caused to assign, based on the one or more allocation parameters and a plurality of rules, one or more pallet location where the item can be unloaded. In an embodiment, the device can be communicatively coupled to the system 200 for sending the voice input to the system 200.

At 504, on receipt of the item identifier, a load distribution information having at least a quantity of the item, an item category of the item, a number of pallets, and a pallet capacity of the pallets for accommodating the item is accessed. In an embodiment, the load distribution information can be predetermined and stored in the memory of the system 200. In an embodiment, the predetermined load distribution information can be stored in a repository communicably coupled to the system 200.

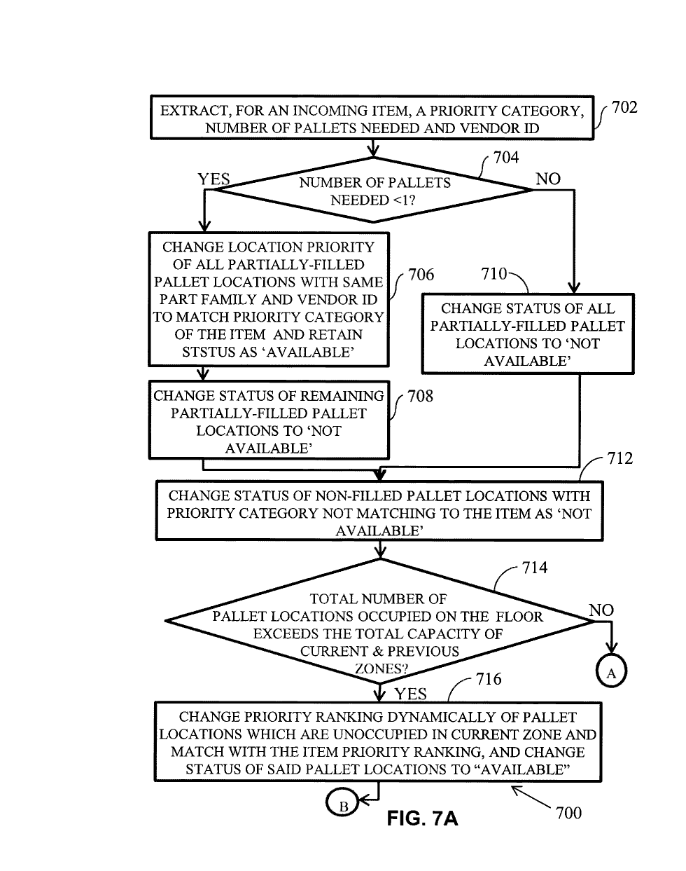

In an embodiment, the load distribution information can be determined prior to arrival of the truck at the distribution center. In an embodiment, the load distribution information is determined based on inventory information regarding quantity and characteristics of the items to be delivered at the distribution center, and a total available floor capacity in the receiving area. An example method for determining the load distribution information is provided with reference to flowchart 600 (FIG. 6). It will be understood that the method 600 is performed on a system, for instance the system 200 (FIG. 2).

At 506, availability of one or more pallet locations from amongst a plurality of pallet locations for accommodating the item is determined. The availability of the one or more pallet locations is determined based on the load distribution information associated with the item and one or more allocation parameters associated with the one or more pallet locations. In an embodiment, the one or more allocation parameters are indicative of the availability of the pallets at the one or more pallet locations in real-time. In an embodiment, the one or more allocation parameters includes a location category associated with the plurality of pallet locations, a location status information, number of continuous unoccupied pallet locations adjacent to a pallet location, item part family information and vendor identifier, percentage of pallet space filled corresponding to a pallet, and a zone information associated with a plurality of zones in the distribution center. In an embodiment, the system 200 may store or may access a plurality of rules pertaining to the one or more allocation parameters for determining the availability of the one or more pallet locations for accommodating the item

For instance, a rule may include determining, based on the load distribution information, whether or not the number of pallets needed for the item is less than one. In an embodiment, if it is determined that the number of pallets needed for accommodating the item is less than one, the status of all the partially filled pallet locations with same part family and vendor ID as that of the item is changed to “Available”. Additionally, the location category of said partially filled pallet locations is changed to match the item category of the item. For example, if the item in question is assigned a priority category as “C” category, the location category of all the partially filled locations with the same part family and vendor ID as that of the item may be changed to “C”. This can be done to expedite the filling of locations which are already filled partially but would need more items to become full.

In an embodiment, if it is determined that the number of pallets needed for accommodating the items is equal to or more than one, the status of the pallets location having a status thereof as “Partially filled” is changed to a status as “Not Available”. In addition, a number of occupied pallet locations based on the status information associated with the plurality of pallets as ‘partially filled’ and ‘not available’ is determined. Also, it is determined whether the number of occupied pallet locations is greater than or equal to a total capacity of a zone and one or more preceding zones in the distribution center. If it is determined that the number of occupied pallet locations is greater than or equal to the total capacity of the zone and one or more preceding zones, the location category corresponding to the plurality of unoccupied pallet locations is changed to match with the item category of the item. This ensures rapid filling of a zone in case the gradual fill was lost due to non-uniform product distribution in the truck.

In an embodiment, based on the one or more allocation parameters, an availability of at least one pallet location associated with the ‘available’ status information and a predefined location category is determined. Also, non-availability of an item associated with the item category same as the predefined location category is determined. For instance, sometimes an unfilled location may be left alone in the receiving area as no more items of the required category with just one pallet load are left in the truck. In such instances, where there are one or more an unfilled pallet locations left in the area, the location category associated with said pallet locations id dynamically changed to match with the item category of the incoming item, thereby ensuring quick filling of pallets at such pallet locations.

In an embodiment, based on the one or more allocation parameters, a number of continuous unoccupied pallet locations adjacent to a pallet location having the location category same as the location category of the item is determined. On determining that the number of continuous unoccupied pallet locations adjacent to the pallet location is less than the number of pallet locations needed for accommodating the item, the status of the pallet location is changed as ‘not available’.

As discussed in various embodiments above, based on the plurality of rules pertaining to the allocation parameters and the load distribution information associated with the item, availability of the one or more pallet locations for accommodating the item is determined. At 508, at least one pallet location is selected from amongst the one or more pallet locations for accommodating the item. In an embodiment, the at least one pallet location is selected based on a location identifier associated with the at least one location. The location identifier associated with a pallet location is indicative of prioritization of the pallet location for accommodating the item, as explained with reference to FIG. 3. In an embodiment, at least one pallet location is selected from amongst the plurality of locations based on the location identifiers associated with the one or more pallet locations. For instance, the location identifiers associated is compared with the one or more pallet locations, and a pallet location associated with highest priority (or lowest location identifier) is selected. In an embodiment, the selected pallet location is communicated to the sorter associate. In an embodiment, the pallet location can be communicated to the sorter associate at the device held by the sorter associate. In an embodiment, the pallet location can be communicated in form of a voice communication/message (or voice file), a text message, and any other similar means of communication.

FIG. 6 illustrates a flow diagram of a method 600 for determining load distribution information, in accordance with the present disclosure. The determination of the load distribution information may facilitate in assigning item categories to various items. Said item categories can be utilized in dynamically allocating pallet locations to different items during unloading of the items from the truck. In an embodiment, the load distribution information can be determined prior to arrival of the truck at the distribution center

At 602, an inventory information associated with the plurality of items is received. In an embodiment, the inventory information may be received at a system, for example, the system 200 (FIG. 2). The inventory information may include information regarding truck details (such as number or identification of the truck), number of items in the truck, expected quantity of the items pertaining to each item, supplier identification (ID) responsible for supplying the items, purchase order (PO) data from a distribution center's warehouse, and so on.

At 604, an item priority data for the plurality of items is computed based on the inventory information. In an embodiment, the method for computing the item priority data is described with reference to blocks 606-612. At 606, a total volume of items arriving in the truck are determined based on the inventory information. For instance, the total volume of products can be determined based on an information of the number of products and characteristics thereof. At 608, an expected number of pallets needed for accommodating the items arriving in the truck, is estimated based on the total volume of items. At 610, a ‘pallet depth’ of each row along the conveyor is determined based on the expected number of pallets. In an embodiment, the pallet depth represents the number of pallets that can be accommodated in a row on the floor of the distribution center. In an embodiment, the pallet depth may be computed as:

$$Pallet depth of a row = \frac{\begin{matrix}Maximum number of rows \\ available in the floor\end{matrix}}{\begin{matrix}Total number of pallet \\ load expected in the truck\end{matrix}}$$

Here, the total number of pallet load may refer to the amount of load being carried by a pallet. The pallet load may be referred to in terms of dimensions (Area×Height) of a pallet with number of cartons as unit of dimension. For instance, a pallet load of 6×3 means 6 cartons in area with 3 carton height in the pallet.

At 612, item categories associated with the plurality of items may be determined. In an embodiment, the item categories associated with the plurality of items are determined based on an item priority ranking being assigned to each item. In an embodiment, the item priority ranking may be computed as below:

Item priority ranking=Volume of the item*Weight of the item

In an embodiment, a number of the item categories is equal to a number of predetermined pallet depth. For instance, in case the pallet depth of a row is 5, then the items may be classified in 5 categories.

At 614, the floor capacity of the receiving area is determined. The determination of the floor capacity of the receiving area facilitates in obtaining a number of pallet locations of each priority category available on the floor of the receiving area. For instance, the floor of the receiving area may be designed in a manner so as to accommodate more number of pallets closer to the conveyer (and thus having higher priority rankings thereof) than the pallets farther from the conveyer (and thus having higher priority rankings thereof). A total number of pallet locations belonging to each priority category is determined. For instance, the location priority ranking associated with the plurality of pallet locations is determined, and the number of pallet locations belonging to each of the location priority ranking category (such as category A, B C, D or E) is determined.

At 616, the pallet locations with corresponding predefined location categories are allocated to respective items based on the item priority ranking associated with the plurality of items. For instance, a pallet location having a location priority ranking as A is allocated to an item having an item priority ranking as A.

At 618, a load distribution information including the allocated priority ranking to the plurality of items is generated. In an embodiment, the load distribution information is provided to an inbound supervisor for validation. In an embodiment, the load distribution information can be utilized in dynamic allocation of pallet locations to the plurality of items.

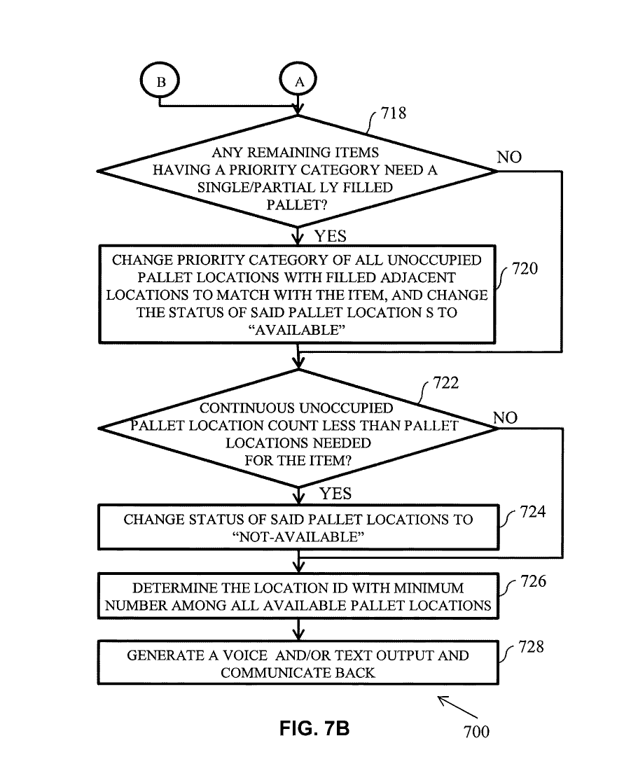

A flow-diagram illustrating a method for dynamically allocating pallet locations to items in a distribution center is described further with reference to FIG. 7.

Referring to FIG. 7, at 702, extract a priority category, number of pallets needed and vendor id for an incoming item (or a SKU). In an embodiment, the priority category, number of pallets needed and vendor id may be extracted from the inventory information, as described with reference to FIG. 6. In an embodiment, the inventory information may be extracted by a system, for example, the system 20 (FIG. 2).

At 704, it is determined whether the number of pallet locations (or pallets) needed for accommodating an incoming item (or SKU) is less than one. If it is determined that the number of pallets needed is less than one, a location priority of all partially-filled pallet locations (or pallets) with same part family and vendor id as that of the incoming items are changed so as to match priority category of the Incoming item, at 706. Also, the status of such pallet locations is retained as ‘available’. Additionally, the status of remaining partially-filled pallet locations is changed to ‘not available’, at 708.

If, at 704 the number of pallet locations (or pallets) needed for accommodating an incoming item (or SKU) is determined to be greater than or equal to one, then status of all partially-filled pallet locations is changed to ‘not available’ at 710. Also, the status of non-filled pallet locations with priority category not matching to the incoming item (or SKU) is changed to ‘not available’, at 712.

At 714, it is determined whether the total number of pallet locations occupied on the floor exceeds the total capacity of current zone and previous zones. If it is determined that the total number of pallet locations occupied on the floor exceeds the total capacity of current zone and previous zones, the priority ranking of said pallet locations which are unoccupied in current zone are dynamically changed and match with the item priority ranking, at 716. Also, the status of said pallet locations is changed to “available”, at 716. Thereafter the process flow goes to 718.

If however, at 714, it is determined that the total number of pallet locations occupied on the floor does not exceeds the total capacity of current zone and previous zones, it is further determined at 718 whether any remaining items having a priority category same as that of the incoming item (or SKU) needs a single/partially filled pallet. If it is determined at 718 that any of the such items (having a priority category same as that of the incoming item (or SKU) needs a single/partially filled pallet) are remaining, then the priority category of all unoccupied pallet locations with filled adjacent locations is changed so as to match with the priority category of the incoming item (or SKU) at 720. In addition, the status of said pallet location is to “available”. Thereafter, the process flow goes to 722.

If however, at 718 it is determined that any of such items (having a priority category same as that of the incoming item (or SKU) needs a single/partially filled pallet) are not remaining, then the process flow goes to 722. At 722, it is determined whether continuous unoccupied pallet location count is less than pallet locations needed for the incoming item. If it is determined at 722 that the continuous unoccupied pallet location count is less than pallet locations needed for the incoming item, the status of said pallet locations is changed to “not-available”, and thereafter the process flow goes to 726. If however, it is determined at 722 that the continuous unoccupied pallet location count is not less than the pallet locations needed for the incoming item, the process flow goes to 726. At 726, the pallet location id with minimum number is determined from among all available pallet locations. At 728, a voice and/or text message is generated regarding the determined pallet location with minimum location id, and the generated message is communicated back to the system. The system may further communicate (through voice command) the determined pallet location id to an associate who is responsible for keeping the items on the pallets.

Various embodiments of the disclosure provide method and system for dynamically allocating pallet locations to items in a distribution center. The method and system disclosed herein facilitate in improving productivity around the inbound process for trucks with very high product mix. Using the disclosed method for sortation of item based on item priority rankings and pallet locations priority rankings helps immensely to reduce sorting time and makes it independent of number of items for even those distribution centers which are devoid of automated sortation for inbound process. A faster unloading helps utilize dock receiving space much better, reduced yard requirement, and reduces demurrage/detention costs for trailers and increases productivity.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A processor-implemented method for real-time allocation of pallet locations to items in a staging area in a distribution center, comprising:
receiving, via one or more hardware processors, an item identifier corresponding to an item from amongst a plurality of items;
accessing, via the one or more hardware processors, and based on the item identifier, a load distribution information comprising at least a quantity of the item, an item category of the item, a number of pallets, and a pallet capacity of the pallets for accommodating the item;
determining, via the one or more hardware processors, availability of one or more pallet locations of a plurality of pallet locations based on the load distribution information associated with the item and one or more allocation parameters associated with the one or more pallet locations, the one or more allocation parameters being indicative of the availability of the pallets at the one or more pallet locations in real-time for accommodating the item; and
selecting, via the one or more hardware processors, at least one pallet location from amongst the one or more pallet locations for accommodating the item, the at least one pallet location being selected based on a location identifier associated with the at least one pallet location, wherein the location identifier associated with a pallet location is indicative of prioritization of the pallet location for accommodating the item.

2. The method of claim 1, wherein the one or more allocation parameters comprises a location category associated with the one or more pallet locations, a location status information, number of continuous unoccupied pallet locations adjacent to a pallet location, item part family information and vendor identifier, percentage of pallet space filled corresponding to a pallet, and a zone information associated with a plurality of zones in the staging area in the distribution center.

3. The method of claim 2, wherein a row of the plurality of rows comprises a plurality of pallet locations, each pallet location of the plurality of pallet locations associated with a location category based on a distance of said pallet location relative to a conveyer, and wherein a pallet location closest to the conveyor in the row is associated with highest location category in the row

4. The method of claim 3, wherein the location status information associated with the pallet location comprises status of the pallet location in real-time, the status of the location one of an available status, a filled status and a partially filled status.

5. The method of claim 2, wherein determining the availability of the one or more pallet locations based on the location status information, the item part family information and the vendor identifier comprises:
determining the number of pallets for accommodating the item to be less than one;
determining, based on the one or more allocation parameters and the load distribution information, the one or more pallet locations of the plurality of pallet locations having item part family information and the vendor identifier same as the item part family information and the vendor identifier of the item, and current status as partially filled status;
changing the location category of the one or more pallet locations to match with the item category associated with the item; and
changing the status information of the one or more pallet locations to the ‘available status’ to indicate the availability of the one or more pallet locations.

6. The method of claim 2, wherein determining the availability of the one or more pallet locations based on the location status information, the item part family information, the vendor identifier and the zone information comprises:
determining the number of pallets for accommodating the item to be at least one;
determining, in real-time, a number of occupied pallet locations based on the status information associated with the plurality of pallets as ‘partially filled’ and ‘not available’;
changing the status information of pallet locations having the ‘partially filled’ status to ‘not available’ status;
determining whether the number of occupied pallet locations is greater than or equal to a total capacity of a zone and one or more preceding zones in the staging area, wherein the staging area comprises a plurality of zones, each zone comprising a set of pallet locations from amongst the plurality of pallet locations, and each zone being associated with a zone ranking indicative of a prioritization of the zone relative to other zones of the plurality of zones, and wherein a preceding zone of a zone is associated with a higher pallet ranking as compared to the pallet ranking of the zone; and determining the number of occupied pallet locations is greater than or equal to the total capacity of the zone and one or more preceding zones; and
changing the location category corresponding to the plurality of unoccupied pallet locations of the one or more preceding zones to match with the item category of the item to indicate the availability of the one or more pallet locations.

7. The method of claim 6, further comprising:
determining, based on the one or more allocation parameters, availability of one pallet location with unoccupied adjacent pallet locations, and having the ‘available’ status and a predefined location category;
determining, non-availability of an item associated with the item category same as the predefined location category needing a single pallet location; and
changing the location category of the corresponding pallet location to match with the item category of the item.

8. The method of claim 7, further comprising:
determining, based on the one or more allocation parameters, a number of continuous unoccupied pallet locations adjacent to a pallet location having the location category same as the location category of the item; and
changing the status of the pallet location as ‘not available’ on determination of number of continuous unoccupied pallet locations adjacent to the pallet location less than the number of pallet locations needed for accommodating the item

9. The method of claim 1, further comprising assigning the item category to the item based at least on a weight and a volume of the item

10. A processor-implemented system for real-time allocation of pallet locations to items in a staging area in a distribution center, the system comprising:
one or more memories; and
one or more hardware processors, the one or more memories coupled to the one or more hardware processors wherein the one or more hardware processors are capable of executing programmed instructions stored in the one or more memories to:
receive an item identifier corresponding to an item from amongst a plurality of items;
access, based on the item identifier, a load distribution information comprising at least a quantity of the item, an item category of the item, a number of pallets, and a pallet capacity of the pallets for accommodating the item;
determine, for accommodating the item, availability of one or more pallet locations of a plurality of pallet locations based on the load distribution information associated with the item and one or more allocation parameters associated with the one or more pallet locations, the one or more allocation parameters being indicative of the availability of the pallets at the one or more pallet locations in real-time; and
select at least one pallet location from amongst the one or more pallet locations for accommodating the item, the at least one pallet location being selected based on a location identifier associated with the at least one pallet location, wherein the location identifier associated with a pallet location is indicative of prioritization of the pallet location for accommodating the item.

11. The system of claim 10, wherein the one or more allocation parameters comprises a location category associated with the one or more pallet locations, a location status information, number of continuous unoccupied pallet locations adjacent to a pallet location, item part family information and vendor identifier, percentage of pallet space filled corresponding to a pallet, and a zone information associated with a plurality of zones in the staging area in the distribution center.

12. The system of claim 11, wherein a row of the plurality of rows comprises a plurality of pallet locations, each pallet location of the plurality of pallet locations associated with a location category based on a distance of said pallet location relative to a conveyer, and wherein a pallet location closest to the conveyor in the row is associated with highest location category in the row.

13. The system of claim 12, wherein the location status information associated with the pallet location comprises status of the pallet location in real-time, the status of the location one of an available status, a filled status and a partially filled status.

14. The system of claim 13, wherein to determine the availability of the one or more pallet locations based on the location status information, the item part family information and the vendor identifier, the one or more hardware processors are further configured by the instructions to:
determine the number of pallets for accommodating the item to be less than one;
determine, based on the one or more allocation parameters and the load distribution information, the one or more pallet locations of the plurality of pallet locations having item part family information and the vendor identifier same as the item part family information and the vendor identifier of the item, and current status as partially filled status;
change the location category of the one or more pallet locations to match with the item category associated with the item; and
change the status information of the one or more pallet locations to the ‘available status’ to indicate the availability of the one or more pallet locations.

15. The system of claim 13, wherein to determine the availability of the one or more pallet locations based on the location status information, the item part family information, the vendor identifier and the zone information, the one or more hardware processors are further configured by the instructions to:
determine the number of pallets for accommodating the item to be at least one;
determine, in real-time, a number of occupied pallet locations based on the status information associated with the plurality of pallets as ‘partially filled’ and ‘not available’;
change the status information of pallet locations having the ‘partially filled’ status to ‘not available’ status;
determine whether the number of occupied pallet locations is greater than or equal to a total capacity of a zone and one or more preceding zones in the staging area, wherein the staging area comprises a plurality of zones, each zone comprising a set of pallet locations from amongst the plurality of pallet locations, and each zone being associated with a zone ranking indicative of a prioritization of the zone relative to other zones of the plurality of zones, and wherein a preceding zone of a zone is associated with a higher pallet ranking as compared to the pallet ranking of the zone;
determine the number of occupied pallet locations is greater than or equal to the total capacity of the zone and one or more preceding zones; and
change the location category corresponding to the plurality of unoccupied pallet locations of the one or more preceding zones to match with the item category of the item.

16. The system of claim 15, wherein the one or more hardware processors are further configured by the instructions to:
determine, based on the one or more allocation parameters, availability of one pallet location with unoccupied adjacent pallet locations, and having the ‘available’ status and a predefined location category;
determine, non-availability of an item associated with the item category same as the predefined location category needing a single pallet location; and
change the location category of the corresponding pallet location to match with the item category of the item.

17. The system of claim 16, wherein the one or more hardware processors are further configured by the instructions to:
determine, based on the one or more allocation parameters, a number of continuous unoccupied pallet locations adjacent to a pallet location having the location category same as the location category of the item; and
change the status of the pallet location as ‘not available’ on determination of number of continuous unoccupied pallet locations adjacent to the pallet location less than the number of pallet locations needed for accommodating the item.

18. The system of claim 10, the one or more hardware processors are further configured by the instructions to assign the item category to the item based at least on a weight and a volume of the item.

19. A non-transitory computer-readable medium having embodied thereon a computer program for executing a method for real-time allocation of pallet locations to items in a staging area in a distribution center, the method comprising:
receiving an item identifier corresponding to an item from amongst a plurality of items;
accessing, based on the item identifier, a load distribution information comprising at least a quantity of the item, an item category of the item, a number of pallets, and a pallet capacity of the pallets for accommodating the item;
determining, for accommodating the item, availability of one or more pallet locations of a plurality of pallet locations based on the load distribution information associated with the item and one or more allocation parameters associated with the one or more pallet locations, the one or more allocation parameters being indicative of the availability of the pallets at the one or more pallet locations in real-time; and
selecting at least one pallet location from amongst the one or more pallet locations for accommodating the item, the at least one pallet location being selected based on a location identifier associated with the at least one pallet location, wherein the location identifier associated with a pallet location is indicative of prioritization of the pallet location for accommodating the item.
